(19) United States
(12) Patent Application Publication
(10) Pub. No.: US 2010/0315496 A1
(43) Pub. Date: Dec. 16, 2010

(54) ENDOSCOPE APPARATUS, METHOD AND SYSTEM

(75) Inventor: Hidehiro MIYAYASHIKI, Tokyo (JP)

Correspondence Address: HOLTZ, HOLTZ, GOODMAN & CHICK PC, 220 Fifth Avenue, 16TH Floor, NEW YORK, NY, 10001-7708, US

(73) Assignee: Olympus Corporation, Tokyo (JP)

(21) Appl. No.: 12/732,394

(22) Filed: Mar. 26, 2010

(30) Foreign Application Priority Data
Jun. 15, 2009 (JP) P2009-142116

(51) Int. Cl. H04N 7/18

(52) U.S. Cl. 348/65; 348/135; 348/E07.085

(57) ABSTRACT

An endoscope apparatus includes: an imaging unit that images a subject to generate live streaming video image data; a data adding unit that adds data, which is used for measurement, to only a part of image data constituting the live streaming video image data generated by the imaging unit; and a transmission unit that transmits the live streaming video image data constituted by the image data to which the data used for measurement is added.

### CROSS-REFERENCE TO RELATED APPLICATIONS

Priority is claimed on Japanese Patent Application No. 2009-142116, filed Jun. 15, 2009, the content of which is incorporated herein by reference.

### BACKGROUND OF THE INVENTION

1. Field of the Invention

The present invention relates to an endoscope apparatus, a method and a system for measuring a subject.

2. Description of Related Art

An endoscope apparatus which measures a subject is known. For example, an endoscope apparatus known in the related art includes an optical adapter which is detachably provided and has two optical systems, and calculates three-dimensional coordinates of an any point on the subject by performing coordinate transformation of two images captured through the optical adapter to obtain information on the two images and matching the two images on the basis of the information on the two images.

Here, a display characteristic of the image captured by the endoscope apparatus changes in accordance with a state of the endoscope apparatus (for example, the type of optical adapter). For this reason, in order to perform measurement with high accuracy, the endoscope apparatus corrects the image according to the state of the endoscope apparatus and measures the subject using the corrected image.

However, when an apparatus other than the endoscope apparatus measures the subject using the image captured by the endoscope apparatus, the apparatus other than the endoscope apparatus cannot acquire the information indicating the state of the endoscope apparatus. In this case, when the image cannot be corrected, it is not possible to perform measurement with high accuracy.

An example of a method in which an endoscope apparatus adds information indicating a state of the endoscope apparatus to image data of a captured image is disclosed in Japanese Unexamined Patent Application, First Publication No. 2003-075136.

### SUMMARY OF THE INVENTION

An endoscope apparatus according to an aspect of the present invention includes: an imaging unit that images a subject to generate live streaming video image data; a data adding unit that adds data, which is used for measurement, to only a part of image data constituting the live streaming video image data generated by the imaging unit; and a transmission unit that transmits the live streaming video image data constituted by the image data to which the data used for measurement is added.

### BRIEF DESCRIPTION OF THE DRAWINGS

FIG. 1 is a block diagram showing the configuration of an industrial endoscope apparatus according to an embodiment of the present invention.

FIG. 2 is a block diagram showing the configuration of a data adding unit provided in the industrial endoscope apparatus according to the embodiment.

FIG. 3 is a block diagram showing the configuration of a network transceiver unit provided in the industrial endoscope apparatus according to the embodiment.

FIG. 4 is a block diagram showing the configuration of a network device of the embodiment.

FIG. 5 is a flow chart showing the processing procedure when adding additional data to a plurality of image data captured by the industrial endoscope apparatus of the embodiment.

FIG. 6 is a flow chart showing the processing procedure when the industrial endoscope apparatus of the embodiment performs initial setting of an additional data table.

FIG. 7 is a flow chart showing the processing procedure when the industrial endoscope apparatus of the embodiment changes data addition mode.

FIG. 8 is a flow chart showing the processing procedure when the industrial endoscope apparatus of the embodiment updates optical data stored in the additional data table.

FIG. 9 is a flow chart showing the processing procedure when the industrial endoscope apparatus of the embodiment updates image processing information stored in the additional data table.

FIG. 10 is a flow chart showing the procedure of additional data acquisition processing in which the network device of the embodiment acquires the additional data added to the image data constituting the live streaming video image data transmitted from the industrial endoscope apparatus.

FIG. 11 is a flow chart showing the procedure of stereo measurement processing performed by the network device of the embodiment.

### DETAILED DESCRIPTION OF THE INVENTION

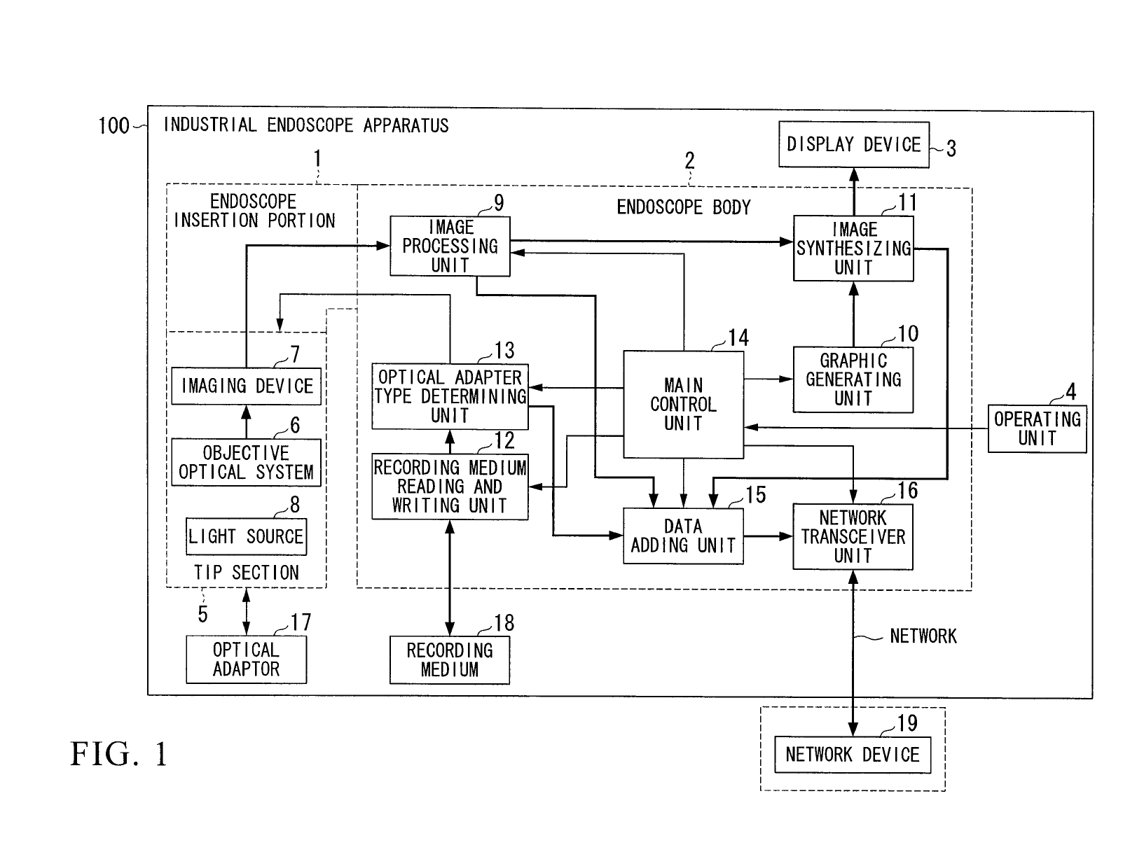

Hereinafter, an embodiment of the present invention will be described with reference to the accompanying drawings. FIG. 1 is a block diagram showing the configuration of an industrial endoscope apparatus according to the embodiment of the present invention. In the example shown in FIG. 1, an industrial endoscope apparatus 100 includes an endoscope insertion portion 1, an endoscope body 2, a display device 3, and an operating unit 4.

The industrial endoscope apparatus 100 captures images of a subject continuously and displays a live streaming video image of the subject by displaying the images continuously. In addition, the industrial endoscope apparatus 100 continuously transmits the continuously captured images of the subject to another apparatus, and another apparatus plays a live streaming video image captured by the endoscope apparatus 100.

The endoscope insertion portion 1 is inserted into an object to be checked. The endoscope body 2 is a main body unit of the industrial endoscope apparatus 100. The display device 3 is an LCD (Liquid Crystal Display) or the like and displays the live streaming video image captured by the industrial endoscope apparatus 100. The operating unit 4 receives an operation instruction from an operator who operates the industrial endoscope apparatus 100.

For example, an inspector (operator) in the examination field inserts the endoscope insertion portion 1 into an object to be inspected, such as a pipe, moves the endoscope insertion portion 1 so that a live streaming video image of a desired check portion is displayed while monitoring the live streaming video image displayed on the display device 3, and performs a check/diagnostic operation on the basis of the live streaming video image. In addition, an inspector who stays in a remote place performs a check/diagnostic operation on the basis of the live streaming video image transmitted from the industrial endoscope apparatus 100 through a communication network by using a network device 19, for example a computer or another industrial endoscope apparatus which is capable to be connected to the communication network, connected to the industrial endoscope apparatus 100.

A tip section 5 of the endoscope insertion portion 1 includes a light source 8, an objective optical system 6 which condenses light from the subject illuminated by the light source 8, and an imaging device 7 which performs photoelectric conversion of a subject image which enters through the objective optical system 6 to generate an image signal and outputs the image signal. In addition, an optical adapter 17 is detachably attached to the tip section 5.

The optical adapter 17 is an adapter which can be exchanged according to an observation purpose of the subject and is formed by lenses and the like capable of performing various imaging. Examples of the optical adapter 17 include an optical adapter formed by one lens, and a stereo optical adapter which is formed by two lenses and performs stereo imaging of the subject. The stereo optical adapter can capture images for performing measurement. For example, measurement process can determine a distance between two points on a surface of the subject.

Note that, even if the same subject is imaged, the industrial endoscope apparatus 100 obtains different image data due to the type and individual differences of the optical adapter 17 attached to the industrial endoscope apparatus 100.

The endoscope body 2 includes an image processing unit 9, a graphic generating unit 10, an image synthesizing unit 11, a recording medium reading and writing unit 12, an optical adapter type determining unit 13, a main control unit 14, a data adding unit 15, and a network transceiver unit 16.

The image processing unit 9 receives the input of the image signal output from the imaging device 7 provided in the tip section 5 of the endoscope insertion portion 1. The image processing unit 9 performs image processing, such as gamma correction processing, edge enhancement processing, and electronic zoom processing, on the input image signal, to generate image data.

The image processing unit 9 outputs the generated image data to the image synthesizing unit 11. In the present embodiment, the imaging device 7 and the image processing unit 9 are collectively assumed to be an imaging unit.

In addition, the image processing unit 9 outputs image processing information to the data adding unit 15. The image processing information is image processing parameters. For example, the image processing information includes information indicating the electronic zoom magnification and a parameter of brightness adjustment. When measurement is performed using an electronically zoomed image, since there is a possibility that the accuracy of measurement will be degraded, a determination that the electronically zoomed image is not used for measurement may be performed by referring to the image processing information.

The graphic generating unit 10 generates image data for graphic user interface (hereinafter, referred to as GUI), such as a menu display. The image synthesizing unit 11 synthesizes the image data output from the image processing unit 9 and the image data for GUI generated by the graphic generating unit 10 to generate image data for displaying one image.

The image synthesizing unit 11 may generate image data of an image based only on the output of the image processing unit 9 (i.e., an image of the subject captured by the industrial endoscope apparatus 100) or may generate image data of an image based only on the output of the graphic generating unit 10 (i.e., an image for GUI).

The image synthesizing unit 11 outputs, to the display device 3 and the data adding unit 15, the image data of the subject captured by the industrial endoscope apparatus 100, the image data for GUI, and the image data obtained by synthesizing the image for GUI with the image of the subject captured by the industrial endoscope apparatus 100.

The display device 3 displays a live streaming video image constituted by a plurality of image data output from the image synthesizing unit 11. In this case, the display device 3 can selectively display a live streaming video image of the subject captured by the industrial endoscope apparatus 100, a live streaming video image for GUI, and a live streaming video image obtained by synthesizing the image for GUI with the image of the subject captured by the industrial endoscope apparatus 100.

A recording medium 18, such as a flash memory card, is detachably connected to the recording medium reading and writing unit 12. When the recording medium 18 is mounted in the recording medium reading and writing unit 12, the recording medium reading and writing unit 12 takes optical data recorded in the recording medium 18 into the industrial endoscope apparatus 100 according to the control of the main control unit 14.

A plurality of optical data is recorded in the recording medium as a optical data group in the present embodiment. The optical data group can include optical data for every type of optical adapter. The optical data includes information indicating optical properties, such as information for correcting distortion of a lens provided in the optical adapter and the focal length. Examples of the optical data of the stereo optical adapter include expressions for geometric distortion correction of two optical systems and information such as the focal length of two lens systems.

An image captured by the industrial endoscope apparatus 100 is distorted due to the optical properties of the optical adapter 17 attached to the industrial endoscope apparatus 100. Since the optical properties are different according to the type of optical adapter, image distortion also changes according to the type of optical adapter attached to the industrial endoscope apparatus 100. For this reason, the optical data of the optical adapter 17 attached to the industrial endoscope apparatus 100 is necessary to correct an image used for measurement.

Hereinafter, the explanation regarding the configuration of the industrial endoscope apparatus 100 will be described. The optical adapter type determining unit 13 determines whether or not the optical adapter 17 is attached to the tip section 5 of the endoscope insertion portion 1. When the optical adapter 17 is attached to the tip section 5, the optical adapter type determining unit 13 determines what type of optical adapter the optical adapter 17 is, according to the control of the main control unit 14. Then, the optical adapter type determining unit 13 selects optical data corresponding to the determined type of optical adapter from the optical data group acquired by the recording medium reading and writing unit 12.

The main control unit 14 controls an operation of the industrial endoscope apparatus 100 by controlling each section, various circuit sections and the like provided in the industrial endoscope apparatus 100.

The data adding unit 15 stores the optical data, as additional data (data used for measurement), selected by the optical adapter type determining unit 13 and the image processing information acquired from the image processing unit 9, in an additional data table. The additional data table is a table for storing the image processing information and the optical data, and is stored in a storage section 15e provided in the data adding unit 15. Details of the storage section 15e will be described later. The image processing information and the optical data used for measurement are collectively assumed to be additional data.

In addition, the data adding unit 15 adds the additional data to all of the image data output from the image synthesizing unit 11 or a part of the image data output from the image synthesizing unit 11. Details of the configuration of the data adding unit 15 and an operation of adding the additional data to the image data will be described later.

The network transceiver unit 16 transmits live streaming video image data, which includes the image data to which the additional data is added by the data adding unit 15, to the network device 19 located in a remote place through the network.

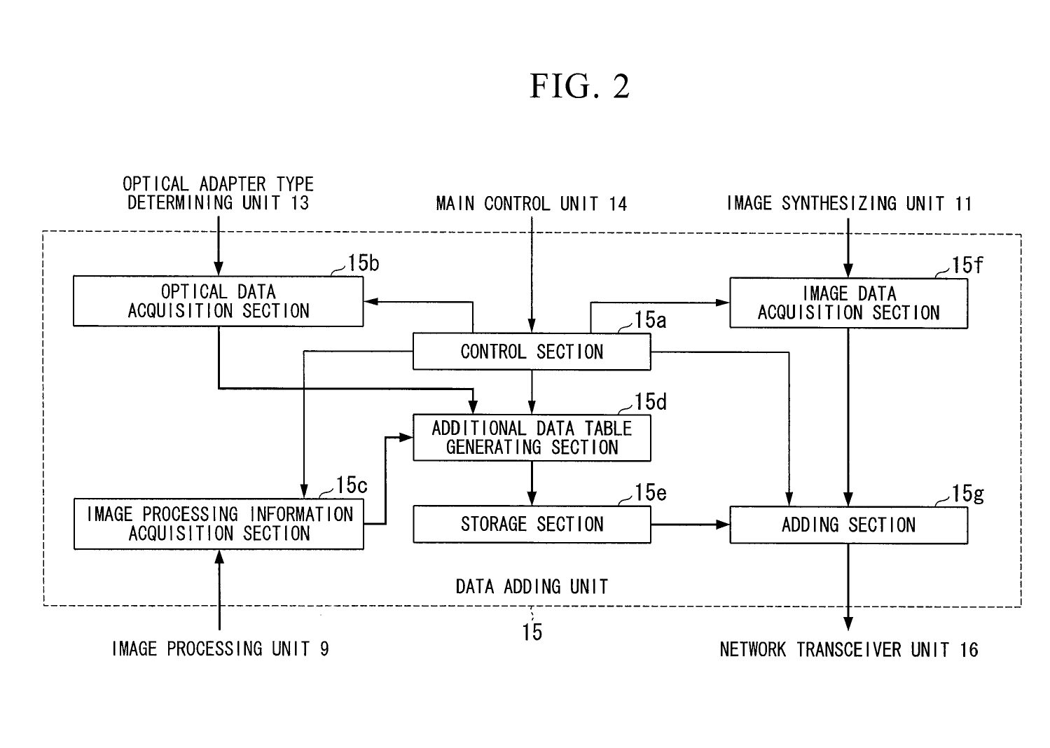

Next, the configuration of the data adding unit 15 provided in the industrial endoscope apparatus 100 of the present embodiment will be described. FIG. 2 is a block diagram showing the configuration of the data adding unit 15 provided in the industrial endoscope apparatus 100 of the present embodiment.

In the example shown in FIG. 2, the data adding unit 15 includes a control section 15a, an optical data acquisition section 15b, an image processing information acquisition section 15c, an additional data table generating section 15d, the storage section 15e, an image data acquisition section 15f, and an adding section 15g.

The control section 15a controls each section provided in the data adding unit 15 according to the control of the main control unit 14. The optical data acquisition section 15b acquires the optical data from the optical adapter type determining unit 13 according to the control of the control section 15a. The image processing information acquisition section 15c acquires the image processing information from the image processing unit 9 according to the control of the control section 15a.

The additional data table generating section 15d generates an additional data table by unifying the optical data acquired by the optical data acquisition section 15b and the image processing information acquired by the image processing information acquisition section 15c according to the control of the control section 15a.

The storage section 15e stores the additional data table generated by the additional data table generating section 15d according to the control of the control section 15a. The image data acquisition section 15f acquires the image data from the image synthesizing unit 11 according to the control of the control section 15a.

The adding section 15g acquires the image data acquired by the image data acquisition section 15f according to the control of the control section 15a. Then, the adding section 15g adds the additional data, which is stored in the additional data table stored in the storage section 15e, to the image data and outputs the result to the network transceiver unit 16. Alternatively, the adding section 15g acquires the image data acquired by the image data acquisition section 15f and outputs the image data to the network transceiver unit 16 according to the control of the control section 15a.

Conditions for the adding section 15g adding the additional data to the image data is set as data addition modes. In the present embodiment, three data addition modes of a “constantly data addition mode” in which the additional data is added to all of the image data captured by the endoscope apparatus 100, a “periodic data addition mode” in which the additional data is periodically added to the image data captured by the endoscope apparatus 100 every predetermined period, and a “change-time data addition mode” in which the additional data is added only to the image data captured by the endoscope apparatus 100 immediately after a change in the additional data, are set as types of data addition mode.

By this configuration, the data adding unit 15 can add the additional data to only a part of the image data captured by the endoscope apparatus 100.

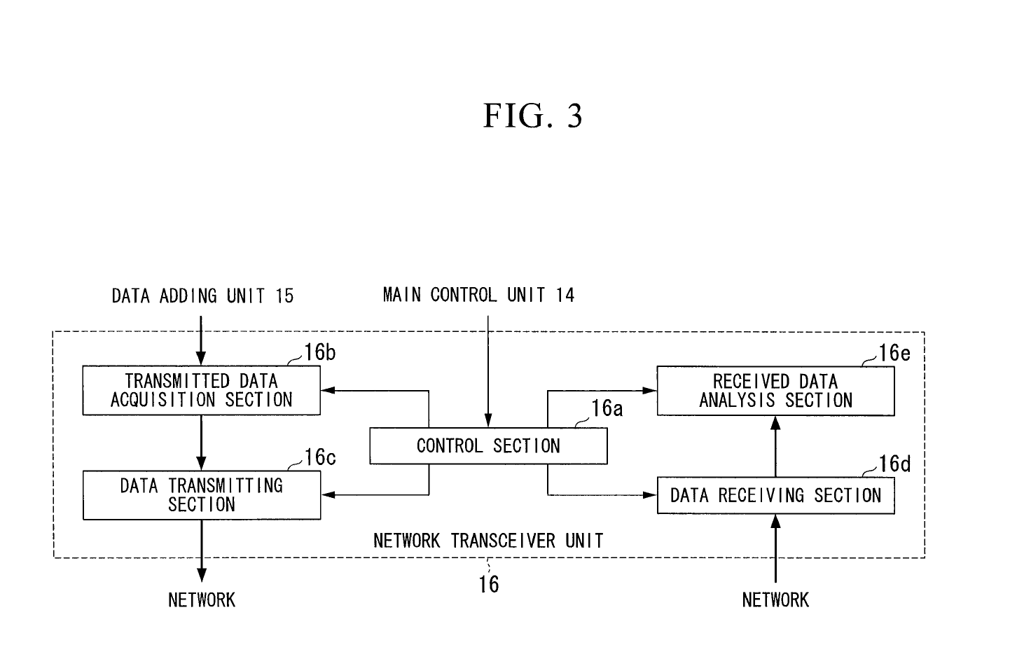

Next, the configuration of the network transceiver unit 16 provided in the industrial endoscope apparatus 100 of the present embodiment will be described. FIG. 3 is a block diagram showing the configuration of the network transceiver unit 16 provided in the industrial endoscope apparatus 100 of the present embodiment.

The network transceiver unit 16 includes a control section 16a, a transmitted data acquisition section 16b, a data transmitting section 16c, a data receiving section 16d, and a received data analysis section 16e.

The control section 16a controls each section provided in the network transceiver unit 16 according to the control of the main control unit 14. The transmitted data acquisition section 16b acquires the image data from the data adding unit 15 according to the control of the control section 16a. The data transmitting section 16c transmits the image data acquired by the transmitted data acquisition section 16b to the network device 19, which is located in a remote place, through the network according to the control of the control section 16a.

The data receiving section 16d receives a response message to the transmission by the transmitted data acquisition section 16b, which is transmitted from the network device 19 through the network, according to the control of the control section 16a. The received data analysis section 16e analyzes the response message received by the data receiving section 16d to determine whether or not the network device 19 has normally received the data-added live streaming video image data, according to the control of the control section 16a.

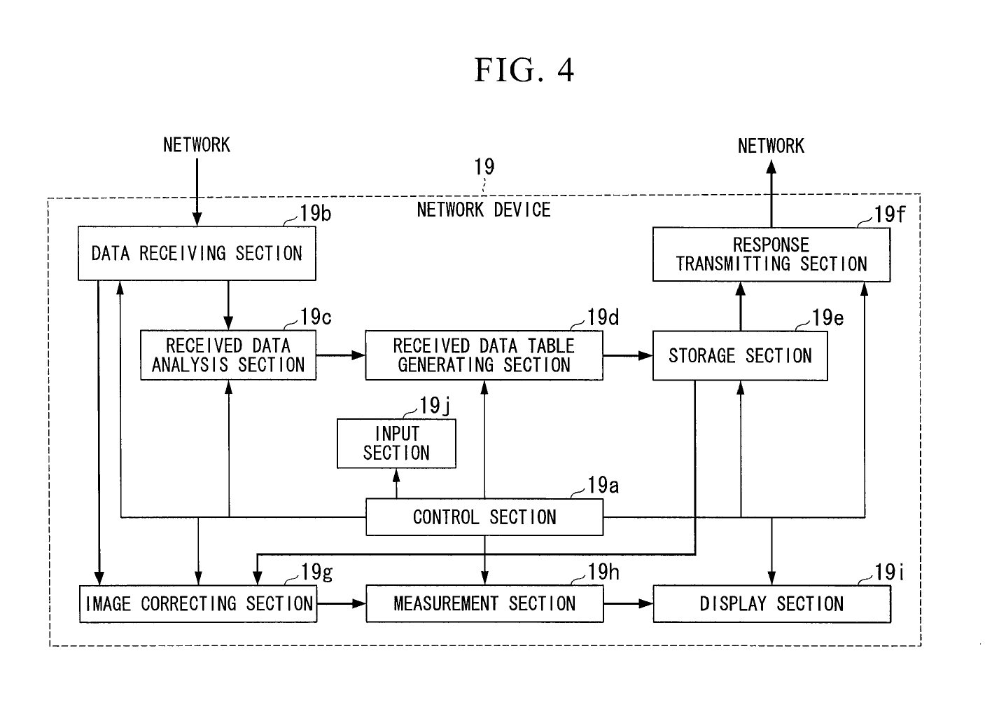

Next, the configuration of the network device 19 of the present embodiment will be described. FIG. 4 is a block diagram showing the configuration of the network device 19 of the present embodiment. The network device 19 includes a control section 19a, a data receiving section 19b, a received data analysis section 19c, a received data table generating section 19d, a storage section 19e, a response transmitting section 19f, an image correcting section 19g, a measurement section 19h, a display section 19i, and an input section 19j.

The control section 19a controls each section provided in the network device 19. The data receiving section 19b receives the image data transmitted from the industrial endoscope apparatus 100 through the network, according to the control of the control section 19a. The received data analysis section 19c acquires the image data received by the data receiving section 19b and analyzes whether or not the additional data is added to the image data according to the control of the control section 19a. When the additional data is added to the image data, the received data analysis section 19c extracts the additional data from the image data.

When the additional data is added to the image data, the received data table generating section 19d generates a received data table in which the additional data extracted by the received data analysis section 19c is stored, according to the control of the control section 19a. The received data table stores the additional data including the optical data and the image processing information.

The storage section 19e stores the received data table generated by the received data table generating section 19d according to the control of the control section 19a. The response transmitting section 19f transmits the response message through the network according to the control of the control section 19a. The image correcting section 19g corrects the image data acquired by the data receiving section 19b by using the additional data stored in the received data table, according to the control of the control section 19a.

The measurement section 19h performs measurement processing of the subject using the image data corrected by the image correcting section 19g according to the control of the control section 19a. The display section 19i is an LCD or the like and displays a live streaming video image, which is constituted by the plurality of image data corrected by the image correcting section 19g, and a measurement result by the measurement section 19h, according to the control of the control section 19a. The input section 19j receives the input of an instruction from the operator.

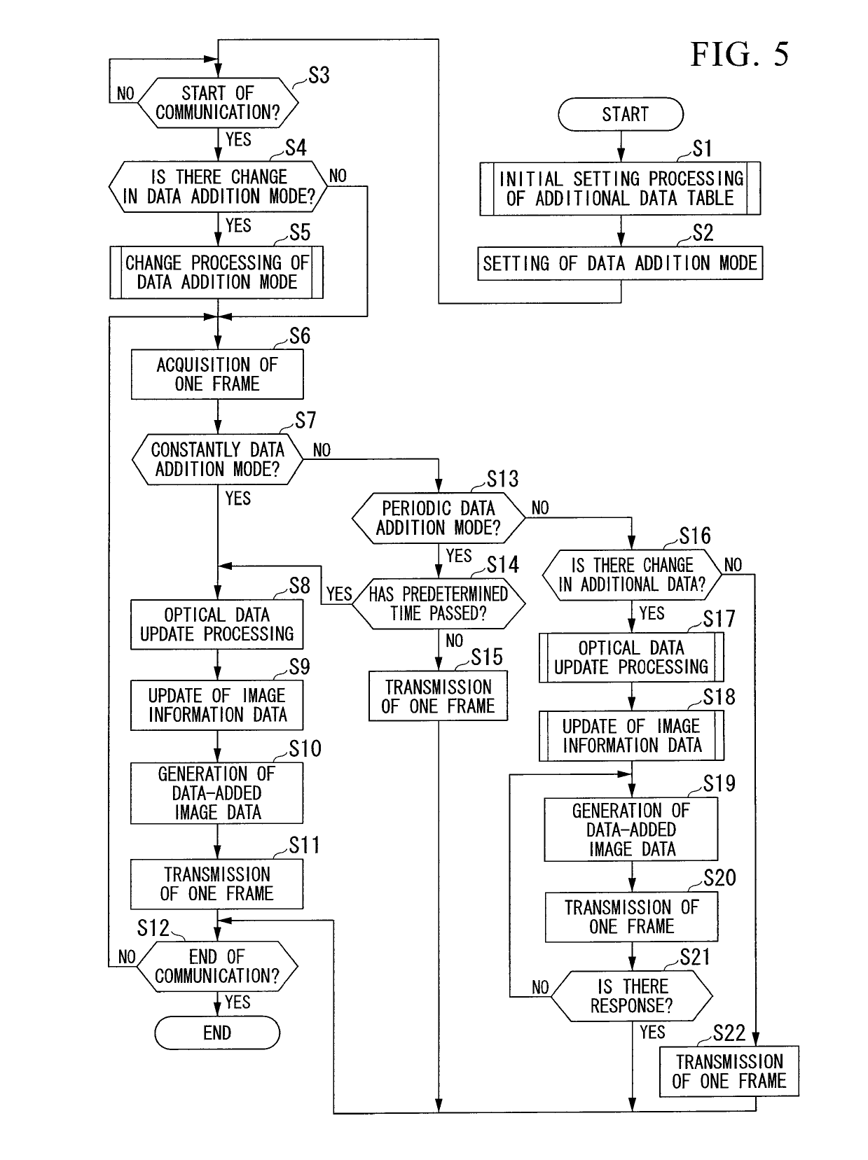

Next, the procedure of adding the additional data to the plurality of image data captured by the industrial endoscope apparatus 100 will be described. FIG. 5 is a flow chart showing the processing procedure when adding the additional data to the plurality of image data captured by the industrial endoscope apparatus 100 of the present embodiment. Although the processing for one of the image data constituting the live streaming video image data will be described below, the same processing is performed for all image data constituting the live streaming video image data.

(Step S1) The main control unit 14 of the industrial endoscope apparatus 100 performs initial setting processing of the additional data table. Then, the process proceeds to step S2. Details of the initial setting processing of the additional data table will be described later.

(Step S2) The operating unit 4 receives an instruction regarding the selection of the type of data addition mode that sets a condition for adding the additional data to the image data. The main control unit 14 sets a data addition mode to the type of data addition mode received by the operating unit 4. Then, the process proceeds to step S3.

In the present embodiment, three data addition modes of a “constantly data addition mode” in which the additional data is added to all of the image data captured by the industrial endoscope apparatus 100, a “periodic data addition mode” in which the additional data is periodically added to the image data captured by the endoscope apparatus 100 every predetermined period, and a “change-time data addition mode” in which the additional data is added only to the image data captured by the endoscope apparatus 100 immediately after a change in the additional data, are set as the type of data addition mode.

(Step S3) The network transceiver unit 16 starts communication with the network device 19. The main control unit 14 determines whether or not the network transceiver unit 16 has started the communication with the network device 19. When the main control unit 14 determines that the network transceiver unit 16 has started the communication with the network device 19, the process proceeds to step S4. In other cases, the process in step S3 is executed again.

(Step S4) When changing the data addition mode, the operator inputs to the operating unit 4 an instruction to change the data addition mode and the type of data addition mode after the change. The main control unit 14 determines whether or not the operating unit 4 has received the instruction of change of the data addition mode. When the main control unit 14 determines that the operating unit 4 has received the instruction of change of the data addition mode, the process proceeds to step S5. In other cases, the process proceeds to step S6.

(Step S5) The main control unit 14 changes the type of data addition mode to the data addition mode input through the operating unit 4 in step S4. Then, the process proceeds to step S6. Details of the process of changing the type of data addition mode will be described later.

(Step S6) The data adding unit 15 acquires the image data of one frame, which constitutes the live streaming video image, from the image synthesizing unit 11 according to the control of the main control unit 14. Then, the process proceeds to step S7.

(Step S7) The main control unit 14 determines whether or not the type of data addition mode, which is set currently, is the “constantly data addition mode”. Here, the main control unit 14 functions as a mode determining unit that determines what type of data addition mode the currently set data addition mode is. When the main control unit 14 determines that the type of data addition mode set currently is the “constantly data addition mode”, the process proceeds to step S8. In other cases, the process proceeds to step S13.

(Step S8) The data adding unit 15 updates the optical data stored in the additional data table according to the control of the main control unit 14. Then, the process proceeds to step S9. Details of the process of updating the optical data stored in the additional data table will be described later.

(Step S9) The data adding unit 15 updates the image processing information stored in the additional data table according to the control of the main control unit 14. Then, the process proceeds to step S10. In addition, details of the process of updating the image processing information stored in the additional data table will be described later.

(Step S10) The data adding unit 15 adds the additional data, which is stored in the additional data table, to the image data acquired in step S6 according to the control of the main control unit 14. Then, the process proceeds to step S11.

(Step S11) The network transceiver unit 16 transmits the image data, to which the additional data is added in step S10, to the network device 19 according to the control of the main control unit 14.

Then, the process proceeds to step S12.

(Step S12) The main control unit 14 determines whether or not to end the communication. When the main control unit 14 determines to end the communication, the process is ended. In other cases, the process returns to step S4.

(Step S13) The main control unit 14 determines whether or not the type of data addition mode, which is set currently, is the “periodic data addition mode”. Here, the main control unit 14 functions as a mode determining unit that determines what type of data addition mode the currently set data addition mode is. When the main control unit 14 determines that the type of data addition mode set currently is the “periodic data addition mode”, the process proceeds to step S14. In other cases, the process proceeds to step S16.

(Step S14) The main control unit 14 determines whether or not a predetermined time has passed since the additional data is added to the image data in step S10. Here, the main control unit 14 functions as a data addition determining unit that determines whether to add the data. When the main control unit 14 determines that the predetermined time has passed since the additional data is added in step S10, the process proceeds to step S8. In other cases, the process proceeds to step S15.

(Step S15) The network transceiver unit 16 transmits the image data acquired in step S6 to the network device 19 according to the control of the main control unit 14. Then, the process proceeds to step S12.

(Step S16) The main control unit 14 determines whether or not there is a change in the additional data.

Here, the main control unit 14 functions as a data addition determining unit that determines whether to add the data. When the main control unit 14 determines that there is a change in the additional data, the process proceeds to step S17. In other cases, the process proceeds to step S22.

Specifically, the optical adapter type determining unit 13 determines whether or not the optical adapter 17 has been exchanged by monitoring the optical adapter 17 attached to the tip section 5 of the endoscope insertion portion 1. When the optical adapter type determining unit 13 determines that the optical adapter 17 has been exchanged, the optical adapter type determining unit 13 determines that there is a change in the optical data. In addition, the main control unit 14 determines whether or not the image processing information, which is used for the image processing by the image processing unit 9, has been changed. The main control unit 14 determines whether or not there is a change in the additional data on the basis of these determinations.

(Step S17) The data adding unit 15 updates the optical data stored in the additional data table according to the control of the main control unit 14. Then, the process proceeds to step S18. Details of the process of updating the optical data stored in the additional data table will be described later.

(Step S18) The data adding unit 15 updates the image processing information stored in the additional data table according to the control of the main control unit 14. Then, the process proceeds to step S19. Details of the process of updating the image processing information stored in the additional data table will be described later.

(Step S19) The data adding unit 15 adds the additional data, which is stored in the additional data table, to the image data acquired in step S6 according to the control of the main control unit 14. Then, the process proceeds to step S20.

(Step S20) The network transceiver unit 16 transmits the image data, to which the additional data is added in step S19, to the network device 19 according to the control of the main control unit 14.

Then, the process proceeds to step S21. In addition, the network device 19 transmits the response message to the industrial endoscope apparatus 100 when the image data is received.

(Step S21) The main control unit 14 determines whether or not the network transceiver unit 16 has received the response message transmitted from the network device 19. When the main control unit 14 determines that the network transceiver unit 16 has received the response message transmitted from the network device 19, the process proceeds to step S12. In other cases, the process returns to step S19.

(Step S22) The network transceiver unit 16 transmits the image data acquired in step S6 to the network device 19 according to the control of the main control unit 14. Then, the process proceeds to step S12.

By repeating the process in steps S1 to S22 described above, the industrial endoscope apparatus 100 of the present embodiment can transmit the live streaming video image data constituted by the plurality of image data, which are obtained by imaging the subject and include image data to which the additional data is added according to the addition mode, to the network device 19.

Specifically, in steps S8 to S11, the data adding unit 15 adds the additional data to all of the images constituting the live streaming video image captured by the industrial endoscope apparatus 100. Moreover, in steps S14 and S15 and S8 to S11, the data adding unit 15 periodically adds the additional data to the images constituting the live streaming video image captured by the industrial endoscope apparatus 100, every predetermined time. Moreover, in steps S17 to S22, the data adding unit 15 adds the additional data to the image, which constitutes the live streaming video image captured by the industrial endoscope apparatus 100, immediately after a change in the additional data.

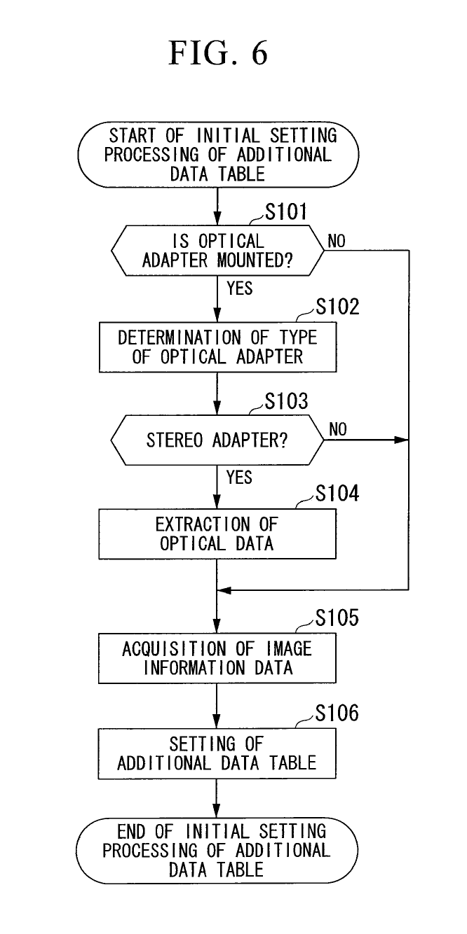

Next, details of the initial setting process of the additional data table which is the process in step S1 will be described. FIG. 6 is a flow chart showing the processing procedure when the industrial endoscope apparatus 100 of the present embodiment performs initial setting of the additional data table. As previously described using the flow chart in FIG. 5, the endoscope apparatus 100 performs initial setting processing of the additional data table at the start of processing of adding the additional data to the captured image data (step S1).

(Step S101) The optical adapter type determining unit 13 determines whether or not the optical adapter 17 is mounted to the tip section 5 of the endoscope insertion portion 1 according to the control of the main control unit 14. When the optical adapter type determining unit 13 determines that the optical adapter 17 is mounted to the tip section 5 of the endoscope insertion portion 1, the process proceeds to step S102. In other cases, the process proceeds to step S105.

(Step S102) The optical adapter type determining unit 13 determines what type of optical adapter the optical adapter 17 mounted to the tip section 5 of the endoscope insertion portion 1 is, according to the control of the main control unit 14. Then, the process proceeds to step S103.

As an example of a method in which the optical adapter type determining unit 13 determines what type of optical adaptor the optical adapter 17 is, there is a method in which the optical adapter 17 has a resistor whose resistance changes according to the type of optical adapter and the optical adapter type determining unit 13 measures the resistance of the resistor provided in the optical adapter 17 and determines, on the basis of the measurement result, what type of optical adapter the optical adapter 17 is.

(Step S103) On the basis of the determination result in step S102, the optical adapter type determining unit 13 determines whether or not the type of optical adapter mounted in the tip section 5 of the endoscope insertion portion 1 is a stereo adapter capable of performing stereo measurement according to the control of the main control unit 14. When the optical adapter type determining unit 13 determines that the type of optical adapter mounted in the tip section 5 of the endoscope insertion portion 1 is a stereo adapter, the process proceeds to step S104. In other cases, the process proceeds to step S105.

(Step S104) The optical adapter type determining unit 13 selects the optical data, which corresponds to the type of the optical adapter 17 mounted in the tip section 5 of the endoscope insertion portion 1, from the optical data group acquired by the recording medium reading and writing unit 12 according to the control of the main control unit 14. Then, the process proceeds to step S105.

(Step S105) The data adding unit 15 acquires the image processing information regarding the endoscope apparatus image from the image processing unit 9 according to the control of the main control unit 14. Then, the process proceeds to step S106.

(Step S106) The data adding unit 15 stores in the additional data table the optical data acquired by the optical adapter type determining unit 13 in step S104 and the image processing information acquired in step S105, according to the control of the main control unit 14. Then, the process is ended. When the process in step S104 is not performed, the data adding unit 15 stores only the image processing information acquired in step S105 in the additional data table according to the control of the main control unit 14.

By this process, the industrial endoscope apparatus 100 of the present embodiment can update the additional data, which includes the image processing information and the optical data stored, in the additional data table, to information in an initial state. That is, the industrial endoscope apparatus 100 can perform initial setting of the additional data table.

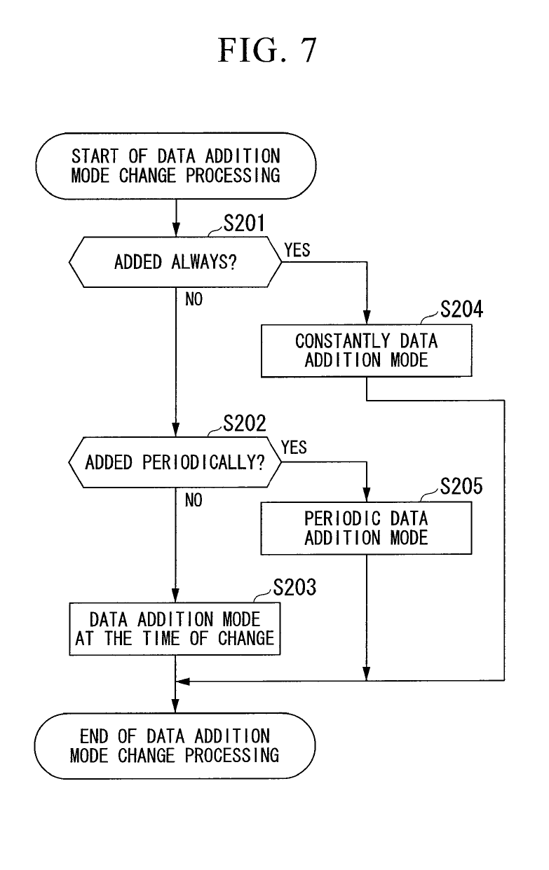

Next, details of the process of changing the data addition mode which is the process in step S5 will be described. FIG. 7 is a flow chart showing the processing procedure when the industrial endoscope apparatus 100 of the present embodiment changes the data addition mode. A plurality of data addition modes are previously set in the endoscope apparatus 100, and the operator can select the type of data addition mode. The process of receiving the operator's instruction regarding the selection of the type of data addition mode is the process in step S2 of the flow chart shown in FIG. 5.

(Step S201) The main control unit 14 determines whether or not the type of data addition mode input through the operating unit 4 in step S4 of the flow chart shown in FIG. 5 is the “constantly data addition mode” which is a mode in which the additional data is added to all of the image data captured by the endoscope apparatus 100. When the main control unit 14 determines that the type of data addition mode input through the operating unit 4 is the “constantly data addition mode”, the process proceeds to step S204. In other cases, the process proceeds to step S202.

(Step S202) The main control unit 14 determines whether or not the type of data addition mode instructed through the operating unit 4 in step S4 of the flow chart shown in FIG. 5 is the “periodic data addition mode” which is a mode in which the additional data is periodically added to the image data captured by the endoscope apparatus 100 every predetermined period. When the main control unit 14 determines that the type of data addition mode input through the operating unit 4 is the “periodic data addition mode”, the process proceeds to step S205. In other cases, the process proceeds to step S203.

(Step S203) The main control unit 14 sets the data addition mode as the “change-time data addition mode”. Then, the process of changing the data addition mode is ended.

(Step S204) The main control unit 14 sets the data addition mode as the “constantly data addition mode”. Then, the process of changing the data addition mode is ended.

(Step S205) The main control unit 14 sets the data addition mode as the “periodic data addition mode”. Then, the process of changing the data addition mode is ended.

By the process in steps S201 to S205 described above, the industrial endoscope apparatus 100 of the present embodiment can change the type of data addition mode and continue the procedure.

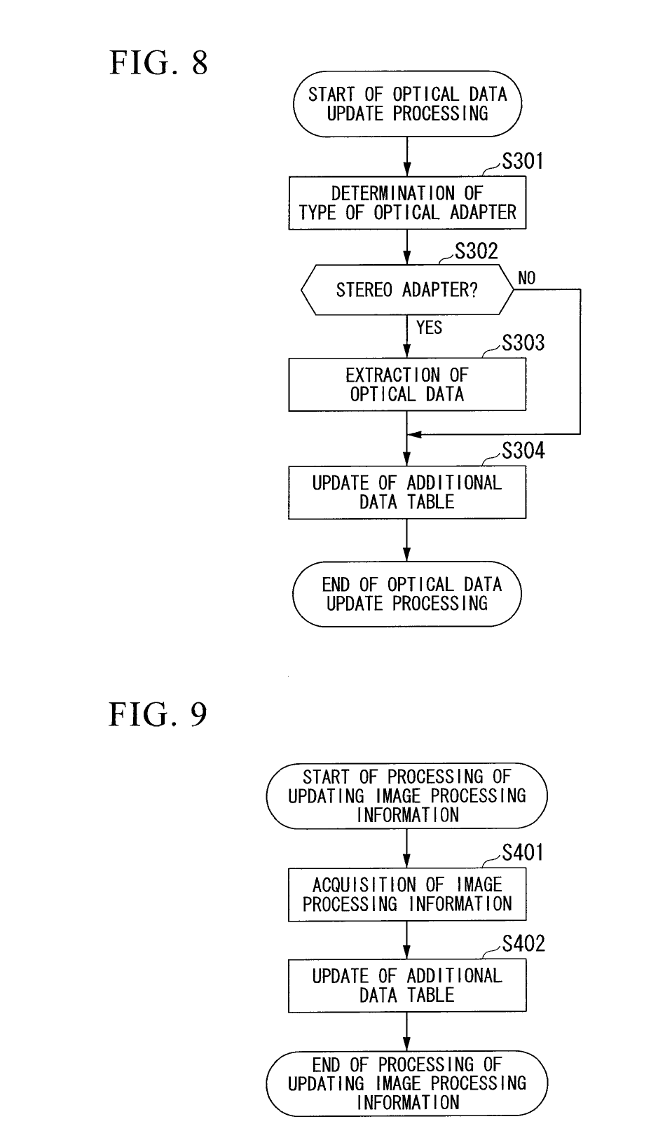

Next, details of the process of updating the optical data stored in the additional data table, which is the process in steps S8 and S17, will be described. FIG. 8 is a flow chart showing the processing procedure when the industrial endoscope apparatus 100 of the present embodiment updates the optical data stored in an additional data table.

(Step S301) The optical adapter type determining unit 13 determines what type of optical adapter the optical adapter 17 mounted in the tip section 5 of the endoscope insertion portion 1 is, according to the control of the main control unit 14. Then, the process proceeds to step S302.

(Step S302) On the basis of the determination result in step S301, the optical adapter type determining unit 13 determines whether or not the type of optical adapter mounted in the tip section 5 of the endoscope insertion portion 1 is a stereo adapter capable of performing stereo measurement according to the control of the main control unit 14. When the optical adapter type determining unit 13 determines that the type of optical adapter mounted in the tip section 5 of the endoscope insertion portion 1 is a stereo adapter, the process proceeds to step S303. In other cases, the process proceeds to step S304.

(Step S303) The optical adapter type determining unit 13 selects the optical data, which corresponds to the type of the optical adapter 17 mounted in the tip section 5 of the endoscope insertion portion 1, from the optical data group acquired by the recording medium reading and writing unit 12 according to the control of the main control unit 14. Then, the process proceeds to step S304.

(Step S304) The data adding unit 15 clears the optical data, which is previously stored in the additional data table, and stores in the additional data table the optical data acquired by the optical adapter type determining unit 13 in step S303. When the optical adapter type determining unit 13 determines that the type of optical adapter mounted in the tip section 5 of the endoscope insertion portion 1 is not a stereo adapter in step S302, the data adding unit 15 stores the information, which indicates that the type of the optical adapter 17 is not a stereo adapter, in the additional data table, instead of the optical data. Then, the endoscope apparatus 100 ends the process of updating the optical data stored in the additional data table.

By the process in steps S301 to S304 described above, the industrial endoscope apparatus 100 of the present embodiment can perform the process of updating the optical data stored in the additional data table.

Next, details of the process of updating the image processing information stored in the additional data table, which is the process in steps S9 and S18, will be described. FIG. 9 is a flow chart showing the processing procedure when the industrial endoscope apparatus 100 of the present embodiment updates the image processing information stored in an additional data table.

(Step S401) The data adding unit 15 acquires the image processing information regarding the endoscope apparatus image from the image processing unit 9 according to the control of the main control unit 14. Then, the process proceeds to step S402.

(Step S402) The data adding unit 15 clears the image processing information, which is previously stored in the additional data table, and stores in the additional data table the image processing information acquired in step S402. Then, the endoscope apparatus 100 ends the process of updating the image processing information stored in the additional data table.

By the process in steps S401 and S402 described above, the industrial endoscope apparatus 100 of the present embodiment can perform the process of updating the image processing information stored in the additional data table.

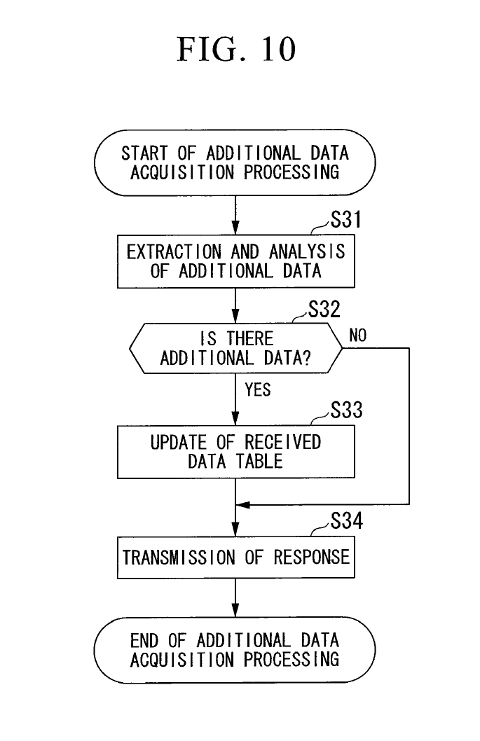

Next, the procedure in which the network device 19 acquires the additional data, which is added to the live streaming video image data transmitted from the industrial endoscope apparatus 100, will be described. FIG. 10 is a flow chart showing the procedure of additional data acquisition processing in which the network device 19 of the present embodiment acquires the additional data, which is added to the image data constituting the live streaming video image data transmitted from the industrial endoscope apparatus 100.

When the network device 19 has started the communication with the endoscope apparatus 100 through the network, the network device 19 is in a reception standby state of awaiting reception of the image data constituting the live streaming video image data transmitted from the endoscope apparatus 100. The network device 19 executes the additional data acquisition processing whenever the image data constituting the live streaming video image data is received.

(Step S31) The received data analysis section 19c of the network device 19 extracts and analyzes the additional data added to the image data that the data receiving section 19b received from the industrial endoscope apparatus 100, according to the control of the control section 19a. Then, the process proceeds to step S32.

(Step S32) The received data analysis section 19c determines whether or not there is additional data added to the image data that the data receiving section 19b received from the industrial endoscope apparatus 100, according to the control of the control section 19a. When the received data analysis section 19c determines that there is additional data added to the image data received from the industrial endoscope apparatus 100, the process proceeds to step S33. In other cases, the process proceeds to step S34.

(Step S33) The received data table generating section 19d clears the additional data, which is previously stored in the received data table stored in the storage section 19e, and stores in the received data table the additional data extracted by the received data analysis section 19c in step S31. Then, the process proceeds to step S34.

(Step S34) The response transmitting section 19f transmits the response message to the industrial endoscope apparatus 100. Then, the network device 19 ends the additional data acquisition processing.

By the process in steps S31 to S34 described above, the network device 19 of the present embodiment can update the additional data stored in the received data table when there is additional data added to the image data received from the industrial endoscope apparatus 100.

In this way, the network device 19 can acquire the additional data (i.e., the optical data and the image processing information) of the image data, which constitutes the live streaming video image data transmitted from the industrial endoscope apparatus 100. Moreover, even if the additional data is updated in the industrial endoscope apparatus 100, the network device 19 can acquire the updated additional data by continuously analyzing the received image data.

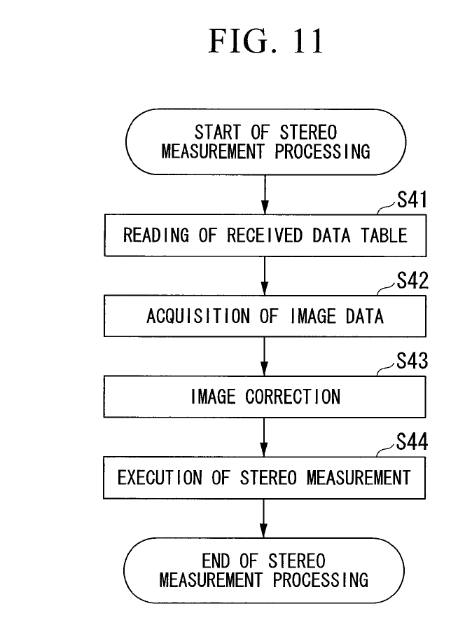

Next, a processing procedure when the network device 19 performs stereo measurement on the basis of the live streaming video image data transmitted from the industrial endoscope apparatus 100 will be described. FIG. 11 is a flow chart showing the procedure of stereo measurement processing in which the network device 19 of the present embodiment performs stereo measurement on the basis of the live streaming video image data transmitted from the industrial endoscope apparatus 100.

When the network device 19 has started the communication with the endoscope apparatus 100 through the network and a measurement instruction is input to the network device 19 by the operator, the network device 19 enters a reception standby state of awaiting reception of the image data constituting the live streaming video image data transmitted from the endoscope apparatus 100.

(Step S41) When starting the stereo measurement processing, the control section 19a of the network device 19 reads the additional data stored in the received data table stored in the storage section 19e.

Then, the process proceeds to step S42.

(Step S42) The image correcting section 19g acquires the image data that the data receiving section 19b receives from the industrial endoscope apparatus 100. Then, the process proceeds to step S43.

(Step S43) The image correcting section 19g reads the additional data stored in the received data table stored in the storage section 19e. Then, the image data acquired in step S42 is corrected using the read additional data. Then, the process proceeds to step S44.

(Step S44) The control section 19a performs measurement using the image which is corrected in step S43 and displays the image and the measurement result on the display section 19h. Then, the network device 19 ends the stereo measurement processing.

When there is information indicating that the type of the optical adapter 17 is not a stereo adapter in the additional data read in step S43, the control section 19a functions as a measurement restriction means and performs control such that the stereo measurement is not performed in step S44. In addition, when the image processing information of the additional data read in step S43 includes information (measurement restriction information) which may degrade the measurement accuracy, for example, information indicating that image processing such as electronic zoom processing has been performed, the control section 19a may perform control such that the measurement processing is not performed using the image captured by the industrial endoscope apparatus 100.

By performing the process in steps S41 to S44 described above, the network device 19 of the present embodiment can measure the subject on the basis of the live streaming video image data received from the industrial endoscope apparatus 100.

As described above, according to the present embodiment, the industrial endoscope apparatus 100 can generate the live streaming video image data in which the additional data is added to only a part of the captured image data. As a result, it is possible to further reduce the processing load when generating the live streaming video image which can be used for measurement of the subject by means of another apparatus.

In addition, the network device 19 continually extracts the additional data added to the image data and continually updates the additional data stored in the received data table. As a result, the network device 19 can correct the image data, to which the additional data is not added, using the additional data stored in the received data table.

In particular, when the additional data is added only to the image data captured immediately after the additional data of the industrial endoscope apparatus 100 is changed, the network device 19 acquires the changed additional data, which is added to the image data captured immediately after the additional data is updated in the industrial endoscope apparatus 100, and updates the additional data stored in the received data table. Accordingly, it is possible to further reduce the processing load when generating the live streaming video image which can be used for measurement of the subject by means of another apparatus.

In addition, all or some of the functions of the industrial endoscope apparatus 100 according to the embodiment described above may be recorded as a program for realizing the functions in a computer-readable recording medium and may be executed the program by reading the program recorded in the recording medium into a computer system. The “computer system” referred here may include an OS or hardware such as peripheral devices.

In addition, examples of the “computer-readable recording medium” include portable media, such as a flexible disk, a magneto-optic disk, a ROM, and a CD-ROM, and a storage device such as a hard disk built in a computer system. In addition, examples of the “computer-readable recording medium” may also include a recording medium that stores a program dynamically for a short period of time like a network such as the Internet, or a communication line when a program is transmitted through a communication line such as a telephone line, and include a recording medium that stores a program for a predetermined period of time like a volatile memory in a computer system which serves as a server or a client in that case. In addition, the above program may be a program for realizing some of the functions described above or may be a program capable of realizing the above functions by combination with a program previously recorded in the computer system. In the case where an endoscope apparatus captures a live streaming video image and an apparatus other than the endoscope apparatus corrects images, which constitute the live streaming video image captured by the endoscope apparatus, and performs measurement of the subject, the endoscope apparatus adds information indicating a state of the endoscope apparatus to the image data of all images constituting the captured live streaming video image in the known method disclosed in Japanese Unexamined Patent Application, First Publication No. 2003-075136. For this reason, there is a possibility that the processing load of the endoscope apparatus may become large. However, according to the endoscope apparatus and the method of the present invention, it is possible to further reduce the processing load when generating a live streaming video image which can be used for measurement of the subject by means of another apparatus.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An endoscope apparatus comprising:
an imaging unit that images a subject to generate live streaming video image data;
a data adding unit that adds data, which is used for measurement, to only a part of image data constituting the live streaming video image data generated by the imaging unit; and
a transmission unit that transmits the live streaming video image data constituted by the image data to which the data used for measurement is added.

2. The endoscope apparatus according to claim 1, wherein when a state of the endoscope apparatus has changed, the data adding unit adds the data used for measurement to the image data constituting the live streaming video image data imaged by the imaging unit immediately after the change.

3. The endoscope apparatus according to claim 2, wherein when an optical adapter attached to the imaging unit has been exchanged, the data adding unit adds the data used for measurement to the image data constituting the live streaming video image data imaged by the imaging unit immediately after the exchange of the optical adapter.

4. The endoscope apparatus according to claim 2, wherein when a parameter of image processing of the endoscope apparatus has changed, the data adding unit adds the data used for measurement to the image data constituting the live streaming video image data imaged by the imaging unit immediately after the change of the parameter.

5. The endoscope apparatus according to claim 1, wherein the data adding unit adds the data used for measurement to the image data every predetermined period.

6. A method comprising:
imaging a subject to generate live streaming video image data;
adding data, which is used for measurement, to only a part of image data constituting the live streaming video image data; and
transmitting the live streaming video image data constituted by the image data to which the data used for measurement is added.

7. A system for measuring a subject comprising:
an endoscope apparatus, the endoscope apparatus comprising:
an imaging unit that images a subject to generate live streaming video image data;
a data adding unit that adds data, which is used for measurement, to only a part of image data constituting the live streaming video image data generated by the imaging unit; and
a transmission unit that transmits the live streaming video image data constituted by the image data to which the data used for measurement is added;
a computer, the computer comprising:
a data receiving unit that receives the live streaming video image data captured by the endoscope apparatus;
a data analysis unit that extract the data for measurement from only the part of the live streaming video image data to which the data adding unit of the endoscope apparatus has added the data for measurement; and
a measurement unit that measures the subject based on the live streaming video data using the data for measurement.

8. The system according to claim 7, the computer further comprising:
a storage unit that stores the data for measurement at every receipt of the data for measurement from the endoscope apparatus,
wherein the measurement unit using the latest data for measurement stored in the storage unit.

9. The system according to claim 8, the computer further comprising:
a data table generating unit that generates a data table containing the data for measurement,
wherein the data table generating unit updates the data for measurement at every receipt of the data for measurement, and
the storage unit stores the data for measurement as the data table generated by the data table generating unit.

10. The system according to claim 8,
wherein the measurement unit measures the subject using image data constituting the live streaming video image data when the data for measurement is not added to the image data by referring the latest data for measurement stored in the storage unit.
